(19) United States
(12) Patent Application Publication
(10) Pub. No.: US 2015/0278088 A1
(43) Pub. Date: Oct. 1, 2015

(54) MEMORY CONTROL APPARATUS, INFORMATION PROCESSING APPARATUS AND CONTROL METHOD THEREOF, AND STORAGE MEDIUM

(71) Applicant: CANON KABUSHIKI KAISHA, Tokyo (JP)

(72) Inventor: Takehiro Ito, Tokyo (JP)

(21) Appl. No.: 14/644,711

(22) Filed: Mar. 11, 2015

(30) Foreign Application Priority Data
Mar. 27, 2014 (JP) 2014-066810

(51) Int. Cl. G06F 12/02; G06F 3/06; G06F 12/10

(52) U.S. Cl. CPC G06F 12/0253; G06F 12/0246; G06F 12/10; G06F 3/0608; G06F 3/0652; G06F 3/0659; G06F 3/0679; G06F 2212/1044; G06F 2212/152; G06F 2212/2022; G06F 2212/657; G06F 2212/7201; G06F 2212/7205

(57) ABSTRACT

A memory control apparatus associates logical addresses with corresponding physical addresses in a non-volatile storage device, and divides the physical addresses in the non-volatile storage device into addresses for complete erasure and other addresses and manages those addresses in the divided manner if a complete erasure mode is set. In the case where data stored in the non-volatile storage device has been instructed to be erased based on a logical address, the memory control apparatus completely erases data at the physical address associated with the logical address in the case where the physical address belongs to the addresses for complete erasure, and cancels a link to the data at the physical address associated with the logical address in the case where the physical address does not belong to the addresses for complete erasure.

### BACKGROUND OF THE INVENTION

1. Field of the Invention

The present invention relates to memory control apparatuses, information processing apparatuses and control methods thereof, and storage media.

2. Description of the Related Art

NAND flash memory controllers that control NAND flash memory are generally known for carrying out wear-leveling to prolong the lifespan of the NAND flash memory. Wear-leveling uses various methods depending on the NAND flash memory controller, and the timing at which the wear-leveling is executed also differs depending on the NAND flash memory controller.

In the case of a configuration where a system controller is connected to the NAND flash memory controller, it is possible that data in tables managed by the system controller may be copied to other blocks in the NAND flash memory after wear-leveling is executed. As such, even if the system controller erases given data for security purposes, it is possible that the data will remain in another location. Accordingly, NAND flash memory controllers may have complete erasure functions in order to completely erase such remaining data. The complete erasure function is a function that completely erases data by overwriting data written by the NAND flash memory controller, and the erasure of data is executed at the block level in the NAND flash memory. For this reason, there is a possibility of decreased performance when erasing data smaller than the NAND flash memory blocks; Japanese Patent Laid-Open No. 2012-191370, for example, proposes a technique to solve this problem.

Japanese Patent Laid-Open No. 2012-191370 discloses dynamically switching the path of an image process based on the security level of a job when the complete erasure mode is enabled.

When the complete erasure mode is turned on, the data stored in the flash memory is completely erased, and thus the security level can be maintained. However, in this case, all of the data in the user region is subject to complete erasure, and thus even data that does not need to be completely erased is completely erased. Completely erasing all of the data is time-consuming and may cause a drop in performance.

### SUMMARY OF THE INVENTION

To solve such problems with the related techniques, the present invention provides a technique that alleviates a drop in performance while maintaining a security level by not treating the entirety of a non-volatile storage device memory as an area to be completely erased and instead managing areas to be completely erased separately from other areas.

According to one aspect of the present invention, there is provided a memory control apparatus that controls access to a non-volatile storage device, the apparatus comprising: an addressing unit configured to associate logical addresses with physical addresses in the non-volatile storage device; a setting unit configured to set a complete erasure mode for completely erasing data in the non-volatile storage device; a management unit configured to divide the physical addresses in the non-volatile storage device into addresses for complete erasure and other addresses and manage those addresses in a divided manner in a case where the complete erasure mode is set by the setting unit; a determination unit configured to, in a case where data stored in the non-volatile storage device has been instructed to be erased based on a logical address, determine whether or not a physical address associated with the logical address belongs to the addresses for complete erasure; and a control unit configured to carry out control for completely erasing data at the physical address associated with the logical address in a case where it is determined by the determination unit that the physical address belongs to the addresses for complete erasure, and canceling a link to the data at the physical address associated with the logical address in a case where it is determined by the determination unit that the physical address does not belong to the addresses for complete erasure.

According to another aspect of the present invention, there is provided an information processing apparatus that accesses a non-volatile storage device, the apparatus comprising: an addressing unit configured to associate logical addresses with physical addresses in the non-volatile storage device; a setting unit configured to set a complete erasure mode for completely erasing data in the non-volatile storage device; a management unit configured to divide the physical addresses in the non-volatile storage device into addresses for complete erasure and other addresses and manage those addresses in a divided manner in a case where the complete erasure mode is set by the setting unit; a determination unit configured to, in a case where data stored in the non-volatile storage device has been instructed to be erased, determine whether or not a physical address of the data belongs to the addresses for complete erasure; and a control unit configured to carry out control for completely erasing the data in a case where it is determined by the determination unit that the physical address belongs to the addresses for complete erasure, and canceling a link between the data and a logical address in a case where it is determined by the determination unit that the physical address does not belong to the addresses for complete erasure.

According to still another aspect of the present invention, there is provided a control method for controlling a memory control apparatus that controls access to a non-volatile storage device, the method comprising: associating logical addresses with physical addresses in the non-volatile storage device; setting a complete erasure mode for completely erasing data in the non-volatile storage device; dividing the physical addresses in the non-volatile storage device into addresses for complete erasure and other addresses and managing those addresses in a divided manner in a case where the complete erasure mode is set in the setting step; determining, in a case where data stored in the non-volatile storage device has been instructed to be erased based on a logical address, whether or not the physical address associated with the logical address belongs to the addresses for complete erasure; and carrying out control for completely erasing data at the physical address associated with the logical address in a case where it is determined in the determining step that the physical address belongs to the addresses for complete erasure, and canceling a link to the data at the physical address associated with the logical address in a case where it is determined in the determining step that the physical address does not belong to the addresses for complete erasure.

According to yet another aspect of the present invention, there is provided a control method for controlling an information processing apparatus that accesses a non-volatile storage device, the method comprising: associating logical addresses with physical addresses in the non-volatile storage device; setting a complete erasure mode for completely erasing data in the non-volatile storage device; dividing the physical addresses in the non-volatile storage device into addresses for complete erasure and other addresses and managing those addresses in a divided manner in a case where the complete erasure mode is set in the setting step; determining, in a case where data stored in the non-volatile storage device has been instructed to be erased, whether or not a physical address of the data belongs to the addresses for complete erasure; and carrying out control for completely erasing the data in a case where it is determined in the determining step that the physical address belongs to the addresses for complete erasure, and canceling a link between the data and the logical address in a case where it is determined in the determining step that the physical address does not belong to the addresses for complete erasure.

According to the present invention, a drop in performance when erasing data in a non-volatile storage device can be alleviated while maintaining the security level of the data in the non-volatile storage device.

Further features of the present invention will become apparent from the following description of exemplary embodiments (with reference to the attached drawings).

### BRIEF DESCRIPTION OF THE DRAWINGS

FIG. 1 is a block diagram illustrating the configuration of an information processing apparatus according to an embodiment.

FIG. 2 is a conceptual diagram illustrating address management in a flash memory according to an embodiment.

FIG. 3 is a diagram illustrating the concept of blocks and pages in a 4-gigabit flash memory according to an embodiment.

FIG. 4 is a conceptual diagram illustrating a link table of a flash memory controller according to an embodiment.

FIG. 5 is a flowchart illustrating a process carried out in the case where the flash memory controller has received a write command, according to an embodiment.

FIGS. 6A-6C are diagrams illustrating transitions in a link table in the case where the flash memory controller has received a write command, according to an embodiment.

FIG. 7 is a flowchart illustrating a process carried out in the case where the flash memory controller has received an erase command, according to an embodiment.

FIGS. 8A and 8B are diagrams illustrating transitions in a link table in the case where the flash memory controller has received an erase command, according to an embodiment.

FIGS. 9A and 9B are diagrams illustrating connection changes in a link table in the case where the flash memory controller has received an erase command, according to an embodiment.

FIG. 10 is a flowchart illustrating a block initialization process for a flash memory carried out by a flash memory controller according to an embodiment.

FIGS. 11A-11C are diagrams illustrating transitions in a link table during the block initialization process for a flash memory carried out by a flash memory controller according to an embodiment.

FIG. 12 is a flowchart illustrating a process in which a flash memory controller provides a complete erasure area in a main area of a link table, according to a first embodiment.

FIG. 13 is a diagram illustrating a state in which the flash memory controller has divided the main area of the link table into a complete erasure area and a normal area, according to the first embodiment.

FIG. 14 is a flowchart illustrating a process in the case where the flash memory controller received a write command when dividing the main area of the link table into a complete erasure area and a normal area and managing those areas, according to the first embodiment.

FIGS. 15A-15C are diagrams illustrating transitions in the link table when the flash memory controller writes data into the complete erasure area, according to the first embodiment.

FIGS. 16A-16C are diagrams illustrating transitions in the link table when the flash memory controller writes data into the normal area, according to the first embodiment.

FIG. 17 is a flowchart illustrating a process carried out when the flash memory controller has received an erase command in the case where the complete erasure area and the normal area are being managed separately, according to the first embodiment.

FIGS. 18A and 18B are diagrams illustrating transitions in the link table when the flash memory controller erases data in the complete erasure area, according to the first embodiment.

FIGS. 19A and 19B are diagrams illustrating changes in blocks in the case where the flash memory controller has received a command to erase data from an address in the normal area, according to the first embodiment.

FIG. 20 is a flowchart illustrating a block initialization process carried out in the case where the flash memory controller manages the complete erasure area and the normal area separately, according to the first embodiment.

FIGS. 21A-21C are diagrams illustrating transitions in the link table during the block initialization process illustrated in FIG. 20.

### DESCRIPTION OF THE EMBODIMENTS

Embodiments of the present invention will now be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention. Hereinafter, a flash memory controller that controls the reading/writing (access) of data from/into a NAND flash memory, serving as a non-volatile storage device, will be described as an embodiment of a memory control apparatus according to the present invention.

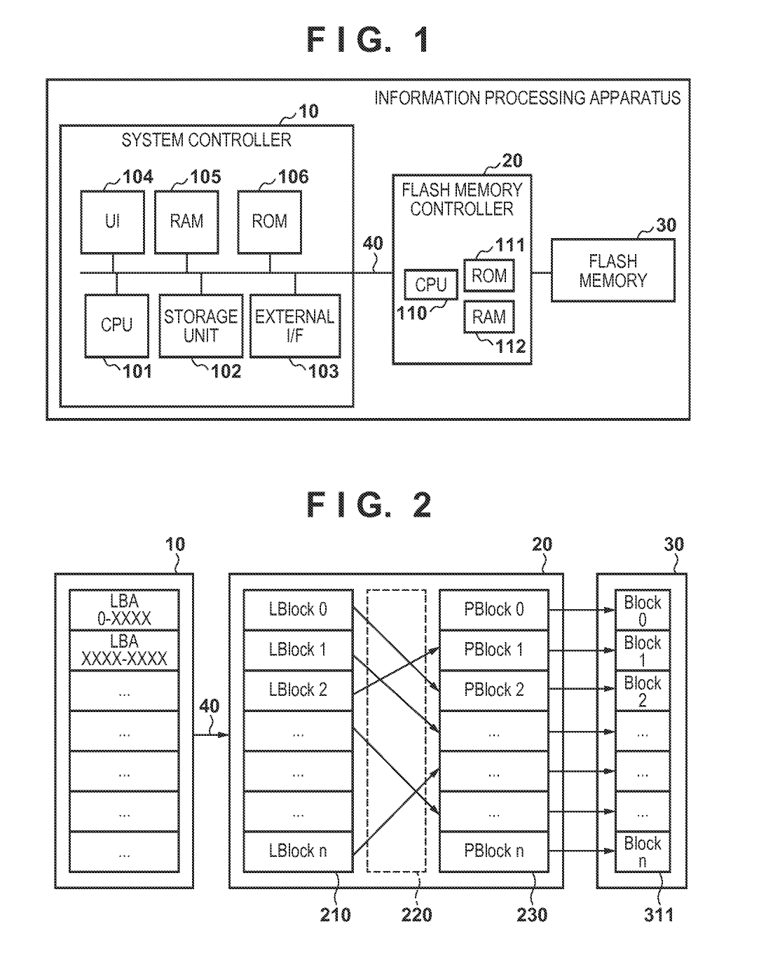

FIG. 1 is a block diagram illustrating the configuration of an information processing apparatus according to the present embodiment.

This information processing apparatus includes a system controller 10 that controls operations of the apparatus as a whole and a NAND flash memory controller (“flash memory controller” hereinafter) 20 that controls a NAND flash memory (“flash memory” hereinafter) 30.

The system controller 10 is connected to the flash memory controller 20 via a generic bus 40. The system controller 10 includes a CPU 101, a storage unit 102, an external I/F 103, a user interface (UI) 104, a RAM 105, and a ROM 106, and these elements are connected to each other via a bus. The CPU 101 reads out a boot program from the ROM 106 and executes the boot program when the apparatus is started up, and loads programs stored in the storage unit 102 into the RAM 105. The CPU 101 then executes the programs loaded into the RAM 105 and controls operations of the apparatus. In addition, the CPU 101 outputs image data to the UI 104 to display a user interface screen. The external I/F 103 is connected to a USB memory or the like.

The flash memory controller 20 includes a CPU 110, a ROM 111, and a RAM 112. The flash memory controller 20 receives commands for the reading, writing, erasing, and so on of data from/into an address in the flash memory 30 designated by the CPU 101 of the system controller 10. Upon receiving a command from the system controller 10, the flash memory controller 20 carries out a process on the flash memory 30 based on the command.

The CPU 110 of the flash memory controller 20 controls operations of the flash memory controller 20 in accordance with a program stored in the ROM 111. The RAM 112 provides a work area in which various types of data used by the CPU 110 during the control performed by the CPU 110 is saved.

FIG. 2 is a conceptual diagram illustrating address management in the flash memory according to this embodiment. Here, an SATA/IF is given as an example of the generic bus 40.

The CPU 101 of the system controller 10 issues, to the flash memory controller 20, a command for reading, writing, and so on from/into an address designated according to LBA. The flash memory controller 20 creates, based on write/erase commands received from the CPU 101, a link table 220 expressing a relationship between logical blocks (LBlock) 210 and physical blocks 230. To describe the link table 220 according to the example shown in FIG. 2, the link table 220 is arranged to connect LBlock0 with PBlock2 and LBlock2 with PBlock1, and this relationship is updated each time wear-leveling is executed. PBlock0, 1, 2, . . . , n, which are the physical blocks 230 in the flash memory controller 20, are connected one-to-one with Block0, 1, 2, . . . , n of blocks 311 in the flash memory 30, and this relationship does not break down.

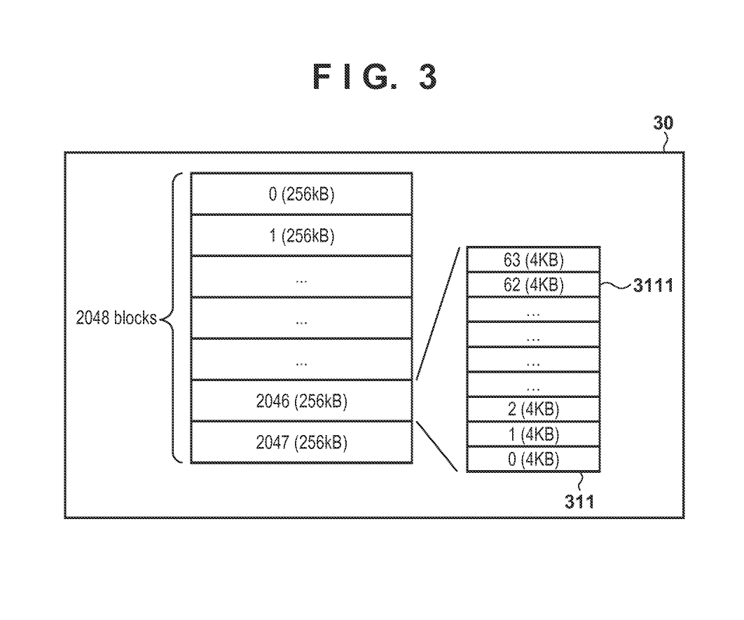

FIG. 3 is a diagram illustrating the concept of blocks and pages in a 4-gigabit flash memory 30 according to this embodiment.

The flash memory 30 has a size of 4 gigabits (=256 Kbits×2,048), and is configured of 2,048 blocks 311, each of which has a size of 256 Kbits (kilobits). Here, each block 311 is configured of 64 pages 3111, and each page 3111 has a size of 4 Kbits. When writing data into the flash memory 30, the flash memory controller 20 writes the data at the page level. On the other hand, when erasing data from the flash memory 30, the flash memory controller 20 erases the data at the block level.

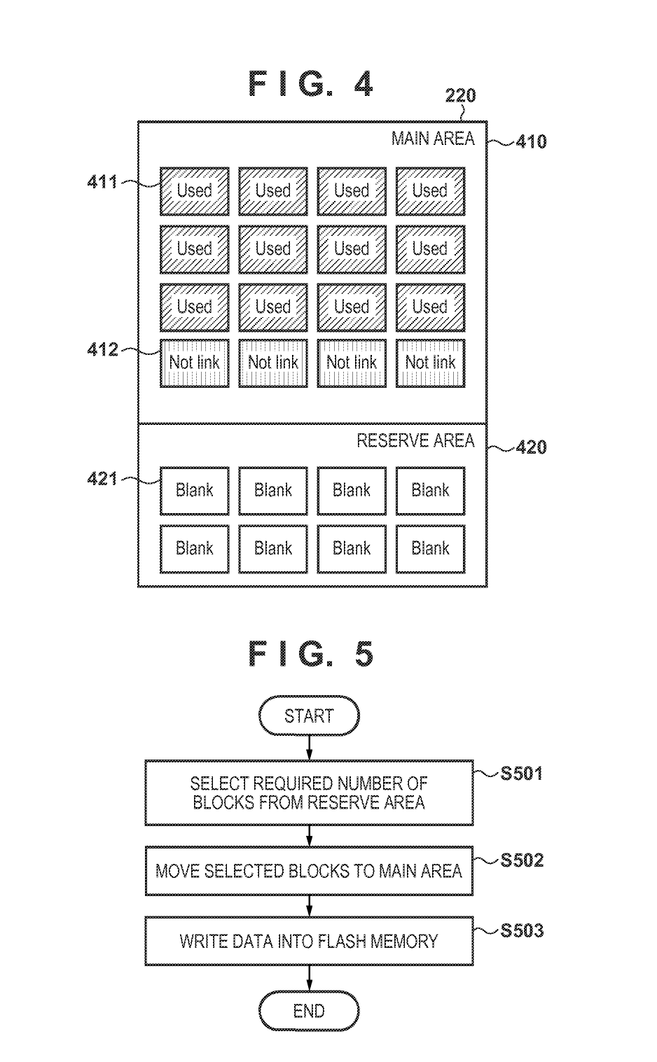

FIG. 4 is a conceptual diagram illustrating the link table 220 in the flash memory controller 20 according to this embodiment, and illustrates a state occurring after data has been written into the flash memory 30.

The link table 220 is configured of two regions, namely a main area 410, which is a user region, and a reserve area 420. Although a system region managed by the flash memory controller 20 also exists in addition to the user region, it should be noted that descriptions of such regions will be omitted in the present embodiment. The main area 410 includes used blocks 411 corresponding to the blocks 311 in the flash memory 30 in which valid data is stored, and blocks 412 corresponding to blocks in the flash memory 30 whose links with the logical blocks 210 have been canceled. The data in the blocks 311 of the flash memory 30 corresponding to the blocks 412 whose links with the logical blocks 210 have been canceled cannot be read out from the system controller 10 due to the links having been canceled. However, in the case where a read command is issued directly to the flash memory 30, that data itself remains in the flash memory 30 and can therefore be read out. The reserve area 420 includes multiple writable empty blocks 421. These writable empty blocks 421 are blocks in which all bits have been initialized to “1” so that the flash memory 30 is writable.

The number of blocks in each of the main area 410 and the reserve area 420 is determined in advance based on the firmware of the flash memory controller 20 and the like, and when the flash memory 30 is in an unused state, all of the blocks in the main area 410 are empty blocks.

FIG. 5 is a flowchart illustrating a process carried out in the case where the flash memory controller 20 has received a write command, according to this embodiment. The programs for executing this process are stored in the ROM 111, and the process is realized by the CPU 110 executing those programs.

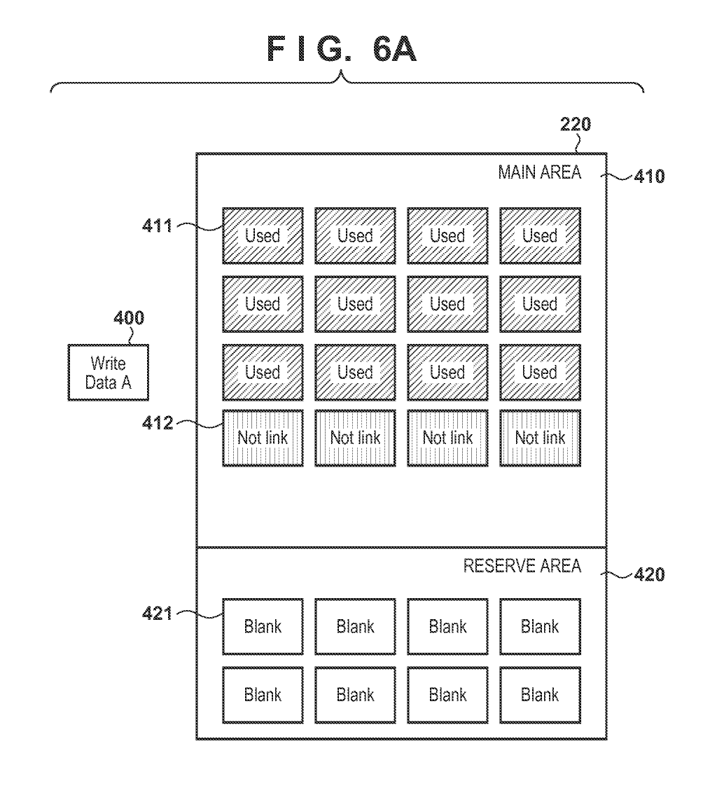

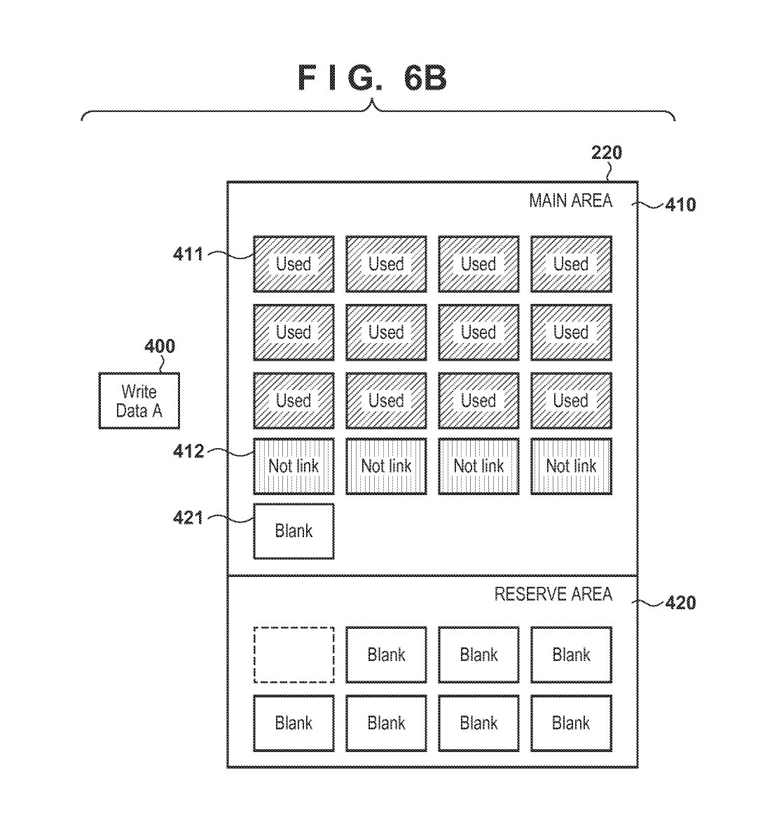

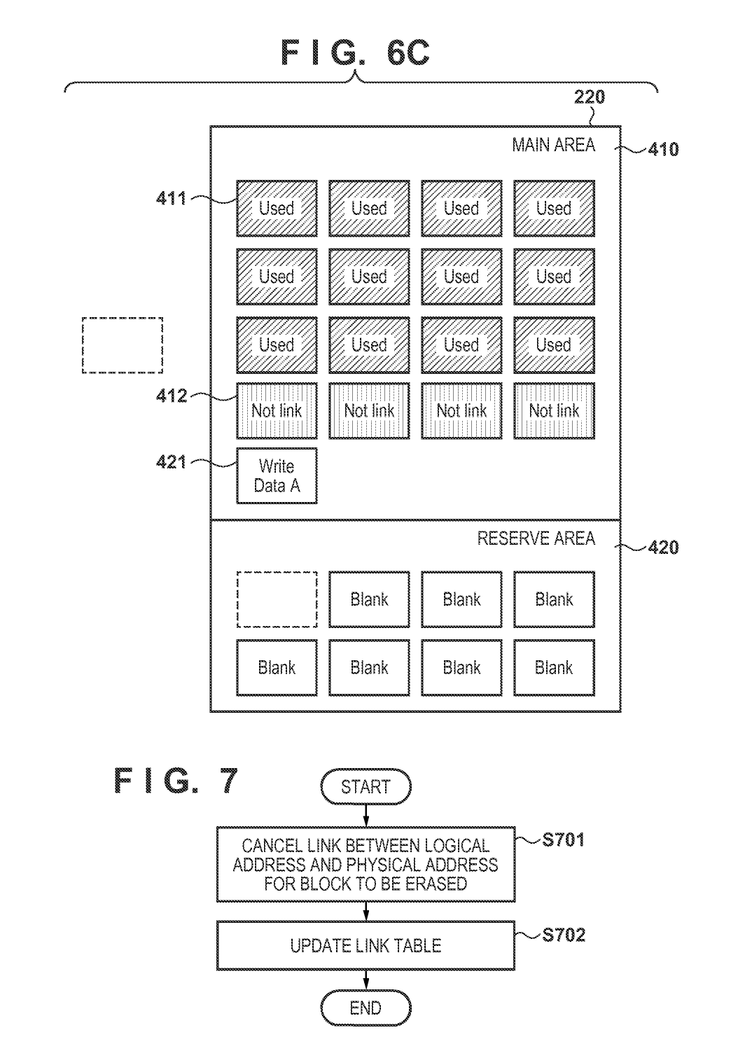

FIGS. 6A-6C are diagrams illustrating transitions in the link table 220 in the case where the flash memory controller 20 has received a write command, according to this embodiment. The flowchart in FIG. 5 will be described with reference to the block transitions in the link table as illustrated in FIGS. 6A-6C.

The process in FIG. 5 starts upon the flash memory controller 20 receiving a write command from the system controller 10. The state of the link table 220 at this time corresponds to the state illustrated in FIG. 6A, and the data to be written in response to the write command is indicated by write data A (400).

First, in step S501, the CPU 110 finds the number of blocks necessary to write the received write data A (400) based on the data size of that data, in order to write the write data A (400) into the flash memory 30. A number of blocks corresponding to the number that has been found are then selected from the reserve area 420. Note that the size of the write data A (400) is assumed to be a size no greater than one block in FIG. 6A.

The process then advances to step S502, where the CPU 110 moves the number of blocks selected in step S501 from the reserve area 420 to the main area 410. FIG. 6B illustrates this state. In FIG. 6B, a single empty block 421 in the reserve area 420 of the link table 220 is moved to the main area 410.

Next, the process advances to step S503, where the CPU 110 writes the data A (400) into the block in the flash memory 30 that corresponds to the block 421 moved to the main area 410 and updates the link table 220, as illustrated in FIG. 6C.

Here, the size of the write data A (400) is no greater than the size of a single block, and thus the number of empty blocks 421 moved from the reserve area 420 to the main area 410 is one. However, in the case where the data size is equivalent to multiple blocks, multiple empty blocks 421 are moved from the reserve area 420 to the main area 410.

FIG. 7 is a flowchart illustrating a process carried out in the case where the flash memory controller 20 has received an erase command, according to this embodiment. The programs for executing this process are stored in the ROM 111, and the process is realized by the CPU 110 executing those programs.

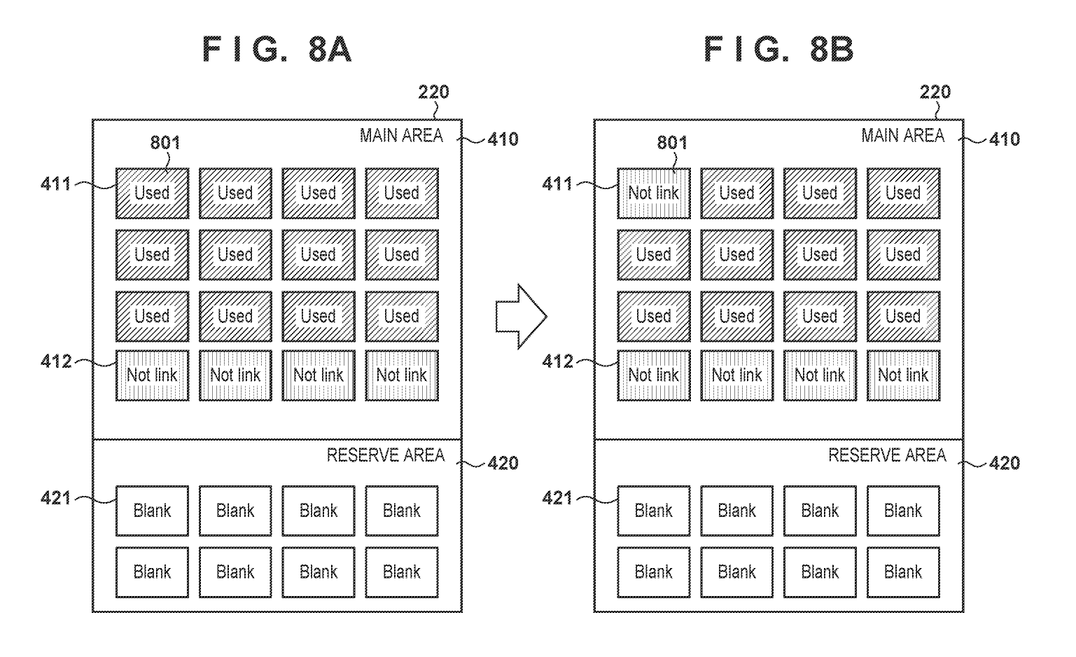

FIGS. 8A and 8B are diagrams illustrating transitions in the link table 220 in the case where the flash memory controller 20 has received an erase command, according to this embodiment.

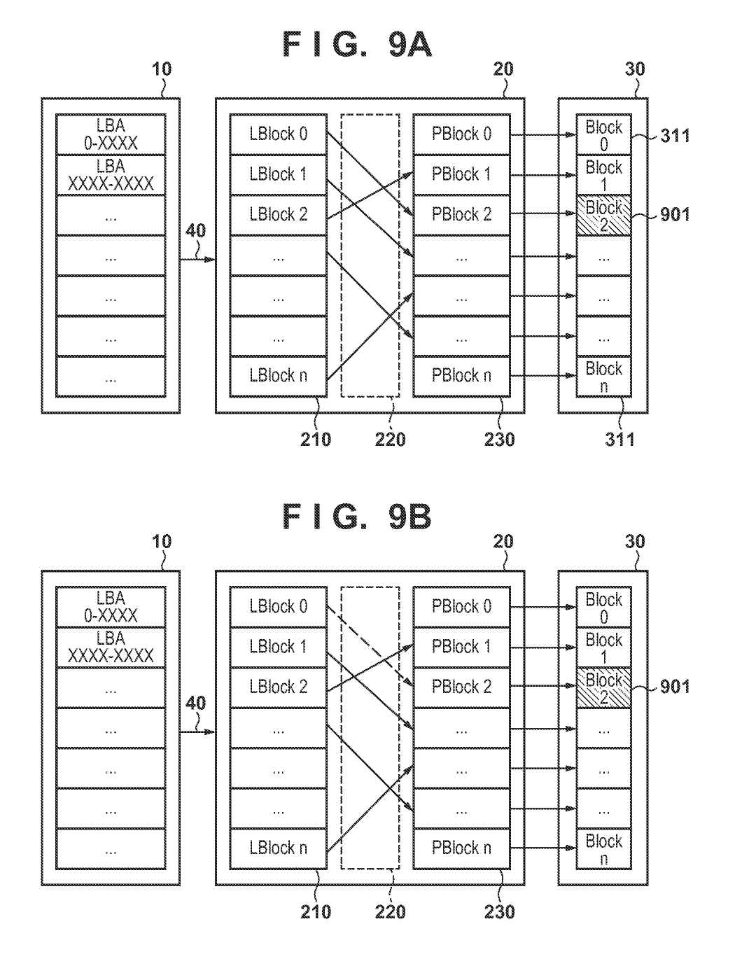

FIGS. 9A and 9B are diagrams illustrating connection changes in the link table 220 in the case where the flash memory controller 20 has received an erase command, according to this embodiment. Hereinafter, the flowchart in FIG. 7 will be described with reference to FIGS. 8A, 8B, 9A, and 9B.

The process in FIG. 7 starts upon the flash memory controller 20 receiving, from the system controller 10, an erase command to erase the data from Block2 (901) in the flash memory 30. At this time, the link table 220 is as illustrated in FIG. 8A, and the connections in the link table 220 are as illustrated in FIG. 9A.

First, in step S701, the CPU 110 cancels the link between the logical address (LBlock0) and the physical address (PBlock2) of the data to be erased. In FIG. 9A, the flash memory controller 20 manages a block 901 of the flash memory 30 in association with the logical address 210 (LBlock0) and the physical block 230 (PBlock2).

FIG. 9B illustrates a state in which the link between LBlock0 and PBlock2 has been canceled due to the flash memory controller 20 receiving a data erase command for Block2 (901) in the flash memory 30.

The process then advances to step S702, where the CPU 110 updates the link table 220 in which the link has been canceled in step S701. At this time, as illustrated in FIG. 8B, the flash memory controller 20 cancels the link of a block 801 in the main area 410 corresponding to Block2 (901) in the flash memory 30. Furthermore, at this time, as illustrated in FIG. 9B, although the link between the block 901 and the logical address in the link table 220 is canceled, the data of Block2 in the flash memory 30 remains in the flash memory 30.

In this manner, when an erase command for data in a given block in the flash memory 30 is received, canceling the link between that block and the logical address renders it impossible to read out the data from that block in the flash memory 30. However, the data remains in that block in the flash memory 30.

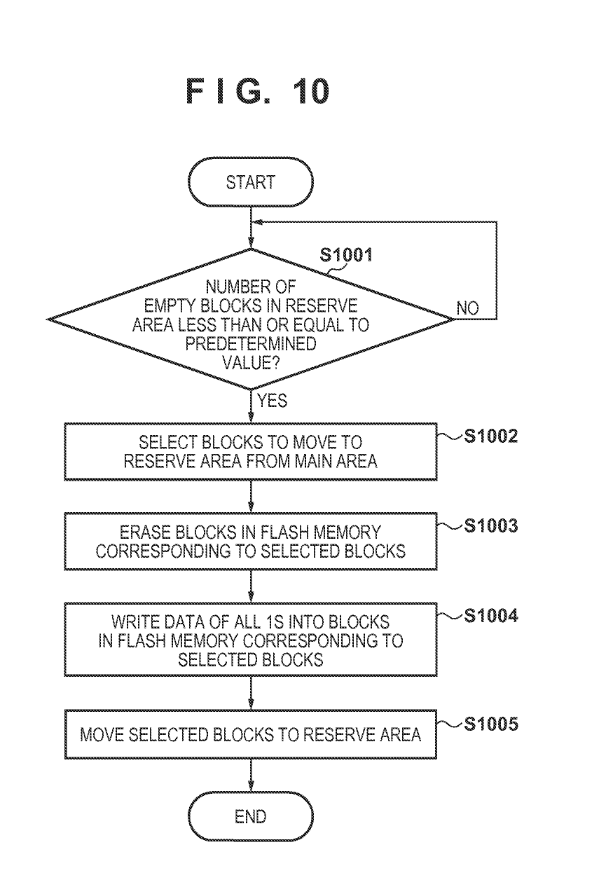

FIG. 10 is a flowchart illustrating a block initialization process for the flash memory 30 carried out by the flash memory controller 20 according to the embodiment. The programs for executing this process are stored in the ROM 111, and the process is realized by the CPU 110 executing those programs.

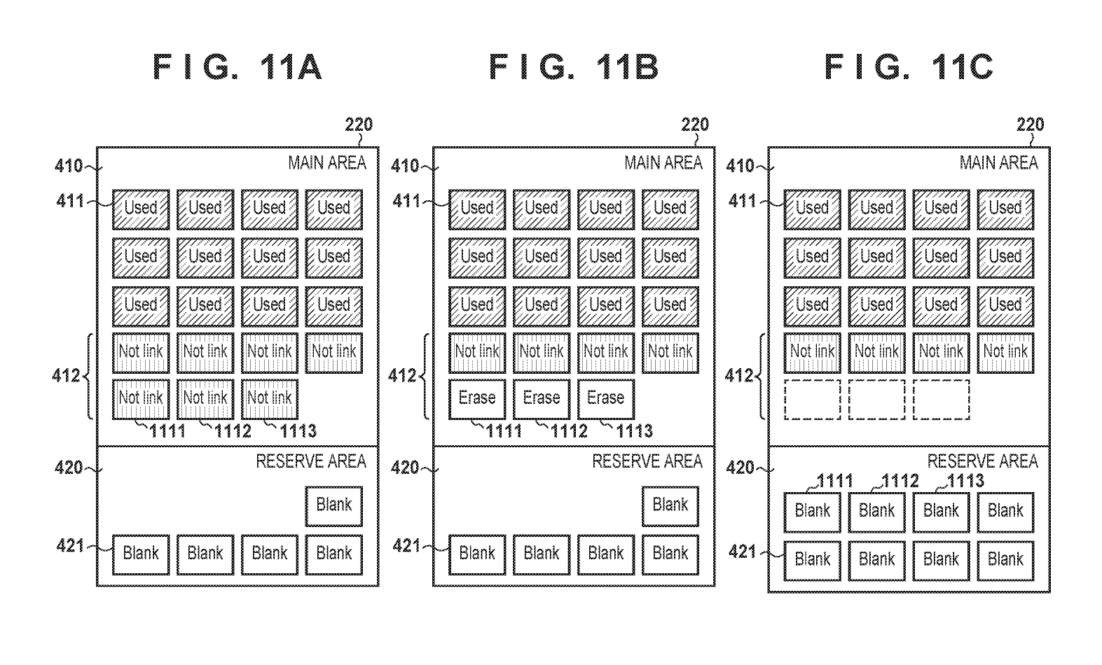

FIGS. 11A-11C are diagrams illustrating transitions in the link table 220 due to the block initialization process for the flash memory 30 performed by the flash memory controller 20 according to this embodiment. Hereinafter, the flowchart in FIG. 10 will be described with reference to FIGS. 11A-11C.

First, in step S1001, the CPU 110 determines whether or not the number of empty blocks in the reserve area 420 is less than or equal to a predetermined value. In FIG. 11A, there are five empty blocks 421 in the reserve area 420. Here, the descriptions will assume that the predetermined value is eight. In FIG. 11A, there are five empty blocks in the reserve area 420, and thus it is determined that the number of blocks in the reserve area 420 is less than or equal to the predetermined value; the process then advances to step S1002.

In step S1002, the CPU 110 selects blocks to move to the reserve area 420 from among the blocks 412 in the main area 410 that have no links. Here, blocks 1111, 1112, and 1113 are selected, as illustrated in FIG. 11A. In this embodiment, the blocks are selected in order from blocks that have been erased the fewest number of times, but a different method may be used for the selection instead.

The process then advances to step S1003, where the CPU 110 writes data of all “0”s into and erases the blocks in the flash memory 30 corresponding to the blocks 1111, 1112, and 1113 selected in step S1002. This erasing releases the charge from the blocks (FIG. 11B).

The process then advances to step S1004, where the CPU 110 writes data of all “1”s into and initializes the blocks in the flash memory 30 corresponding to the blocks 1111, 1112, and 1113 selected in step S1002.

The process then advances to step S1005, where the CPU 110 moves the blocks selected in step S1002 from the main area 410 to the reserve area 420. FIG. 11C illustrates an image of the link table 220 at this time. In FIG. 11C, the blocks 1111, 1112, and 1113 of the main area 410, selected in step S1002, are moved to the reserve area 420.

Note that because the blocks in the flash memory 30 corresponding to the blocks 1111-1113 moved to the reserve area 420 are initialized with data of all “1”s, data can be written to those blocks immediately.

### First Embodiment

Hereinafter, an example in which a complete erasure area 1300 and a normal area 1310 have been provided in the main area 410 of the link table 220, according to the present first embodiment, will be described.

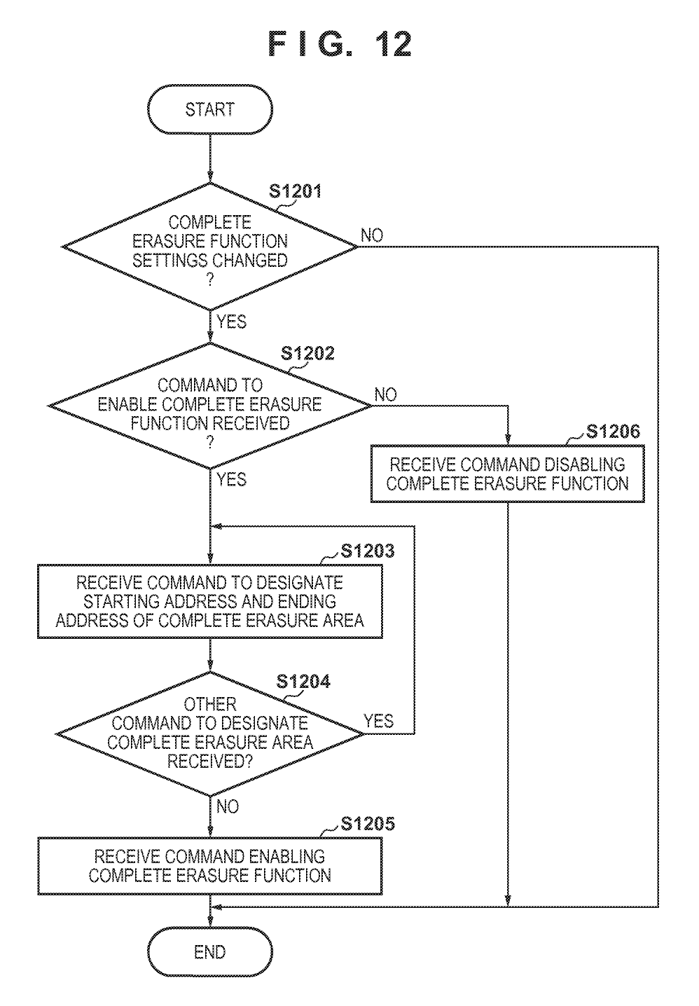

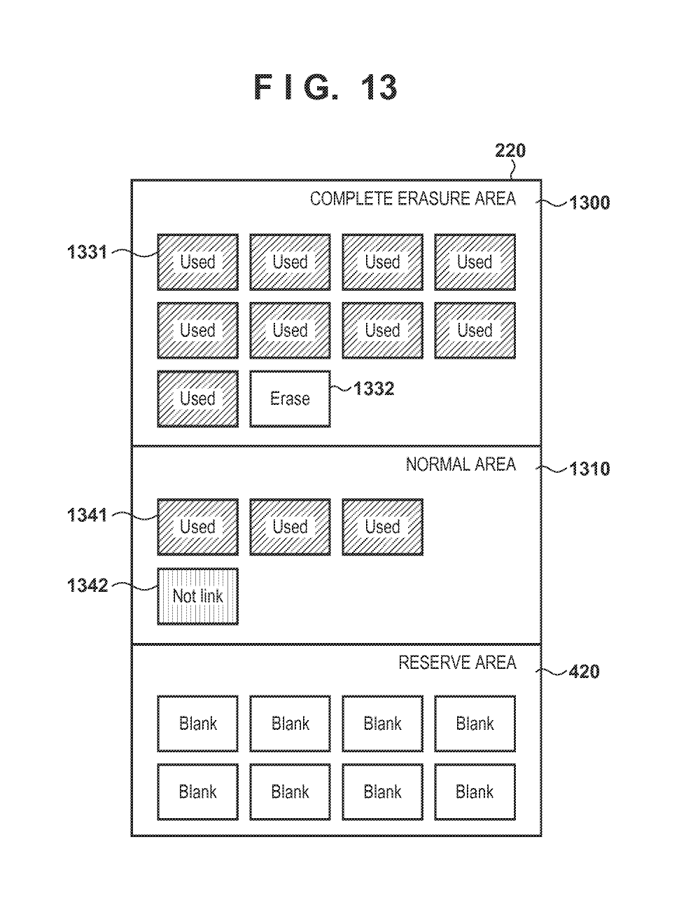

FIG. 12 is a flowchart illustrating a process in which the flash memory controller 20 provides a complete erasure area in the main area of the link table 220, according to the first embodiment. The programs for executing this process are stored in the ROM 111, and the process is realized by the CPU 110 executing those programs.

This process is started when the information processing apparatus according to the first embodiment is turned on. First, in step S1201, the CPU 110 determines whether or not there has been a setting change for the complete erasure function; the process advances to step S1202 in the case where there has been such a setting change, and the process ends directly in the case where there has been no such a setting change. Note that the settings for the complete erasure function are held in the flash memory 30, and the settings held when the information processing apparatus is turned off are then reflected when the information processing apparatus is turned on again. In step S1202, the CPU 110 determines whether or not to enable the complete erasure function. Here, the CPU 110 determines whether or not a command to enable the complete erasure function has been received from the system controller 10; the process advances to step S1203 in the case where the command has been received, whereas the process advances to step S1206 in the case where the command has not been received.

In step S1203, the CPU 110 receives a command to designate a starting address and an ending address of a complete erasure area 1300 from the system controller 10 and stores those settings in the flash memory 30, after which the process advances to step S1204. In step S1204, the CPU 110 determines whether or not another command to designate the complete erasure area 1300 has been received from the system controller 10, and in the case where another command to designate the complete erasure area has been received, the process advances to step S1203 and the aforementioned processing is executed. On the other hand, in the case where another command to designate the complete erasure area has not been received, the process advances to step S1205. In step S1205, the CPU 110 receives the command to enable the complete erasure function from the system controller 10, and this processing then ends. On the other hand, in step S1206, the CPU 110 receives a command to disabling the complete erasure function from the system controller 10, and this processing then ends.

Note that the starting address and the ending address of the complete erasure area 1300 that are set in advance are held in the flash memory 30. Even if the complete erasure function has been disabled, the starting address and the ending address in the complete erasure area 1300 held in the flash memory 30 are simply masked. The complete erasure function settings and the starting address and ending address settings are saved in a system region of the flash memory 30.

In this manner, the flash memory controller 20 according to the first embodiment provides the complete erasure area 1300 and the normal area 1310 in the main area 410, as illustrated in FIG. 13, upon receiving a command to designate the complete erasure area 1300 from the system controller 10.

FIG. 13 is a diagram illustrating an example in which the flash memory controller 20 divides the main area 410 of the link table 220 into the complete erasure area 1300 and the normal area 1310, according to the first embodiment. In FIG. 13, the blocks in the flash memory 30 correspond to the blocks in the complete erasure area 1300 and normal area 1310 and in the reserve area 420.

The complete erasure area 1300 includes blocks 1331 corresponding to used blocks in the flash memory 30 and a block 1332 corresponding to an erased block in the flash memory 30. The blocks in the normal area 1310 include blocks 1341 corresponding to used blocks in the flash memory 30 and a block 1342 whose link with a logical block in the system controller 10 has been canceled.

Here, the erased blocks in the flash memory 30 have been initialized by having data of all “1”s written thereto.

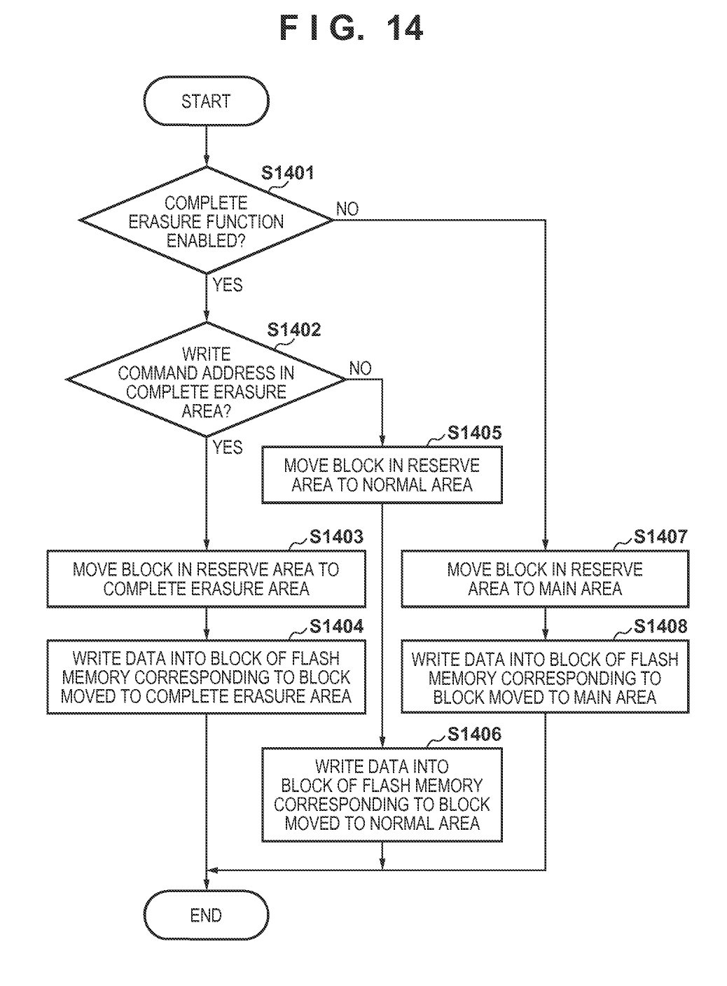

FIG. 14 is a flowchart illustrating a process carried out in the case where the flash memory controller 20 has received a write command while managing the main area 410 of the link table 220 divided into the complete erasure area 1300 and the normal area 1310, according to this embodiment. The programs for executing this process are stored in the ROM 111, and the process is realized by the CPU 110 executing those programs.

This process starts upon the flash memory controller 20 receiving a write command from the system controller 10. First, in step S1401, the CPU 110 reads out the complete erasure function settings stored in the flash memory 30 and determines whether or not the complete erasure function is enabled. The process advances to step S1402 when it is determined that the complete erasure function is enabled, and advances to step S1407 when it is determined that the function is disabled. In step S1402, the CPU 110 determines whether or not a block indicating the write address in the received write command corresponds to a block in the complete erasure area 1300. Here, the process advances to step S1403 when it is determined that the block corresponds to a block in the complete erasure area 1300, and advances to step S1405 when it is determined that the block does not correspond.

In step S1403, the CPU 110 moves the block in the reserve area 420 to the complete erasure area 1300.

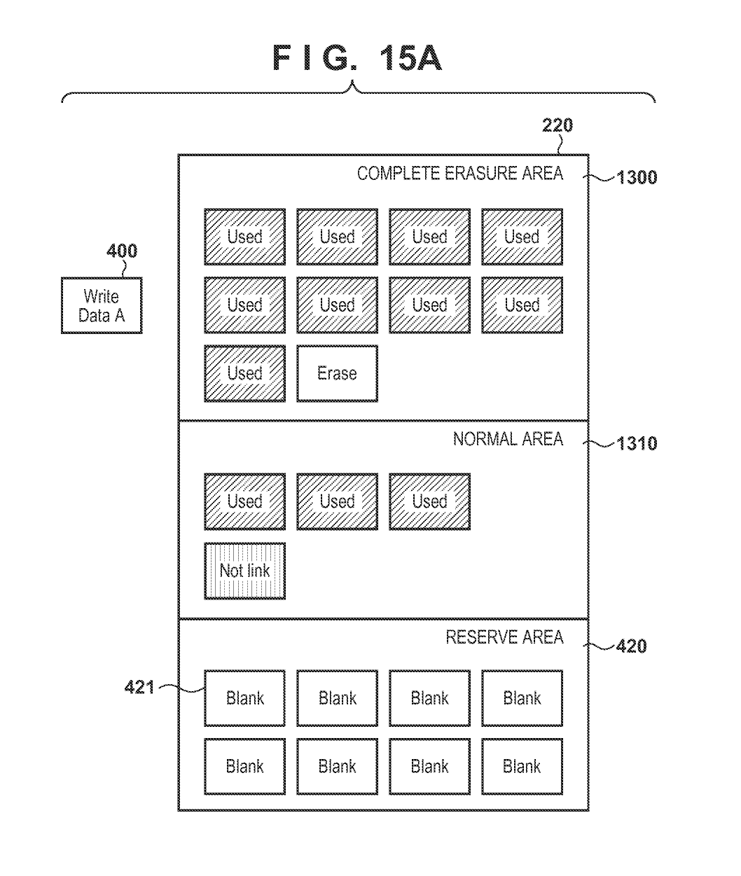

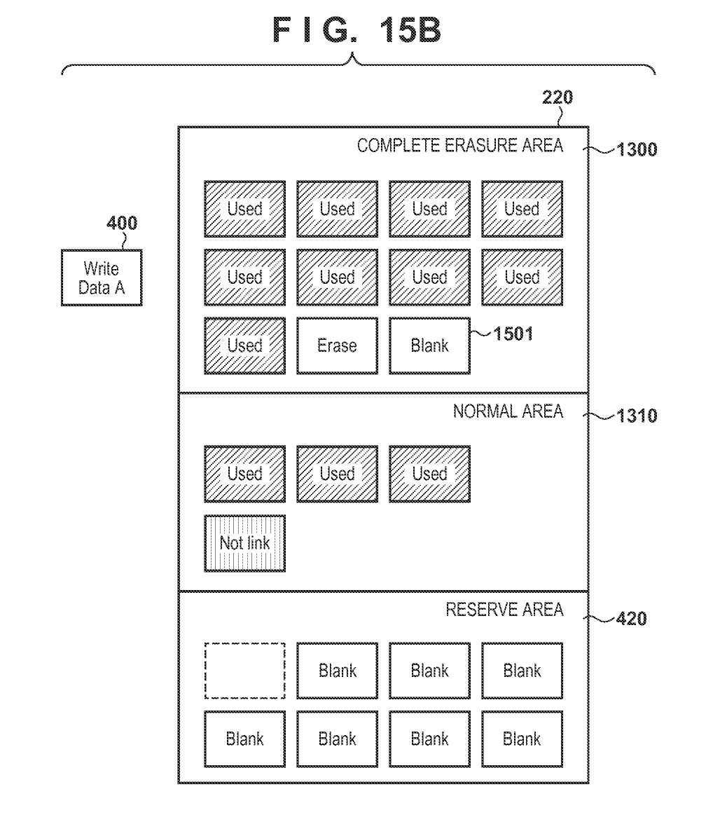

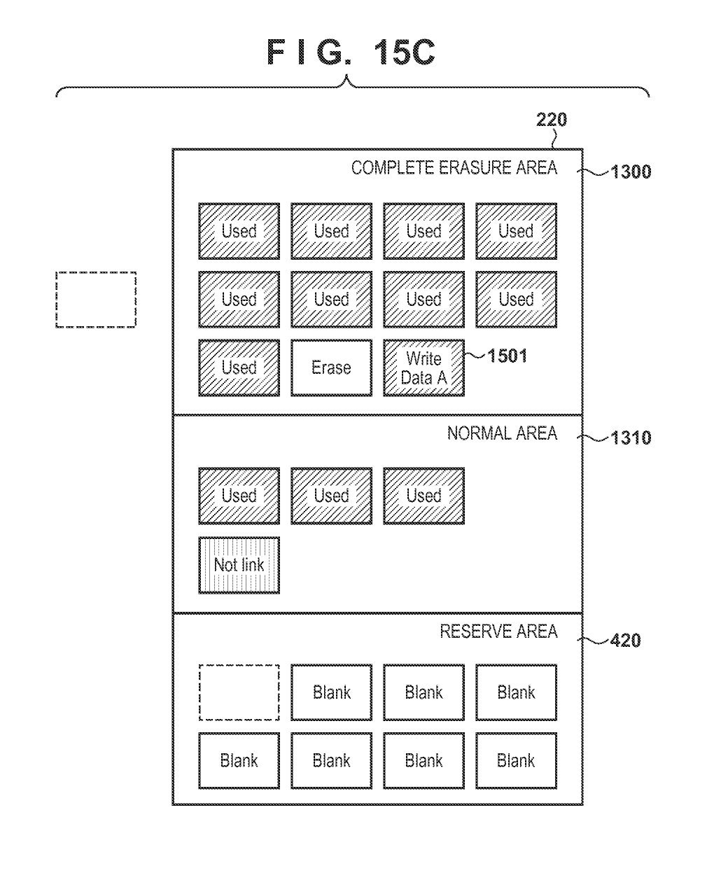

FIGS. 15A-15C are diagrams illustrating transitions in the link table 220 when the flash memory controller 20 writes data into the complete erasure area, according to this embodiment.

FIG. 15A illustrates a state in which the respective blocks are disposed in the complete erasure area 1300, the normal area 1310, and the reserve area 420. Here, the data to be written into the flash memory 30 by the flash memory controller 20 is the write data A (400). FIG. 15B is a diagram illustrating a state in which an empty block 1501 of the reserve area 420 has been moved to the complete erasure area 1300 in order to write data into a block of the flash memory 30 that corresponds to a block in the complete erasure area 1300.

In this manner, when the processing of step S1403 is executed, the process advances to step S1404, where the CPU 110 writes the data A (400) into the block of the flash memory 30 that corresponds to the empty block 1501 moved to the complete erasure area 1300 in step S1403, and ends the processing (FIG. 15C).

Through this, the data designated in the write command is written into a block corresponding to the complete erasure area of the flash memory 30. Accordingly, when the data written into that block is erased, the data is erased according to the complete erasure mode.

On the other hand, in step S1405, the CPU 110 moves the empty block 421 in the reserve area 420 to the normal area 1310.

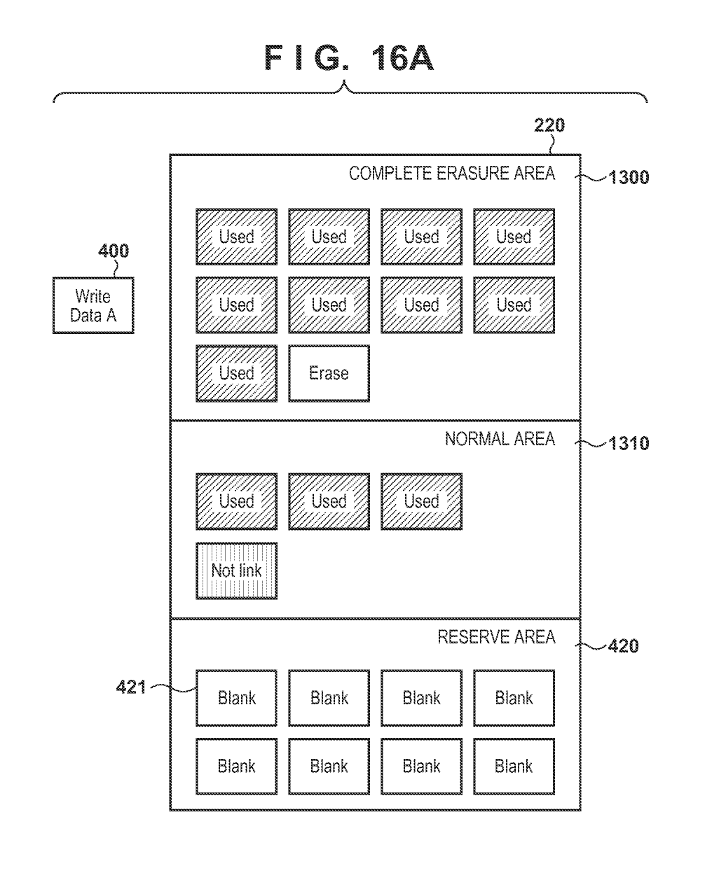

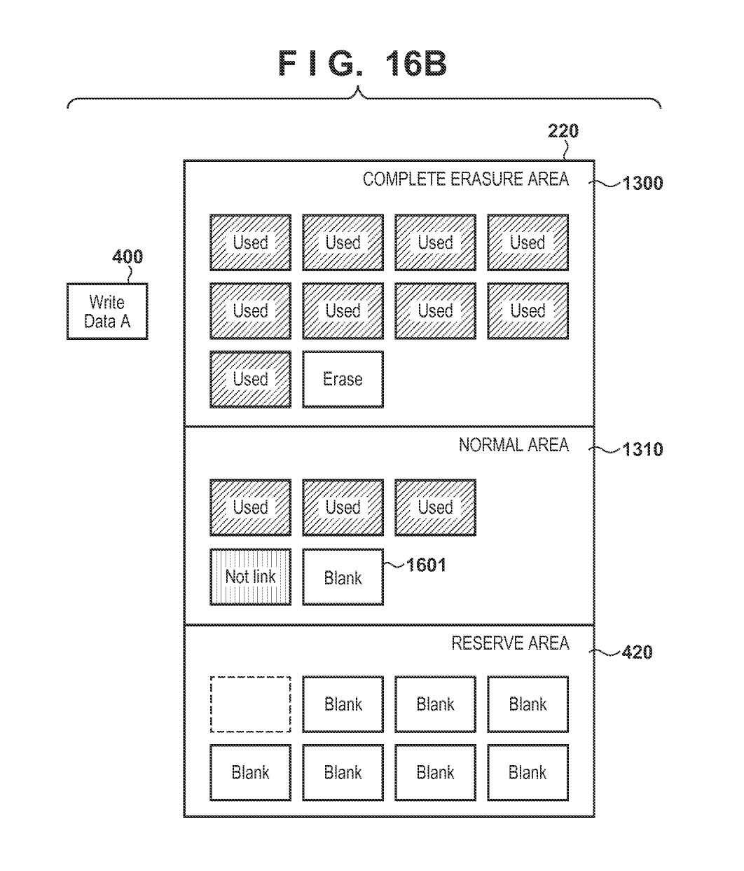

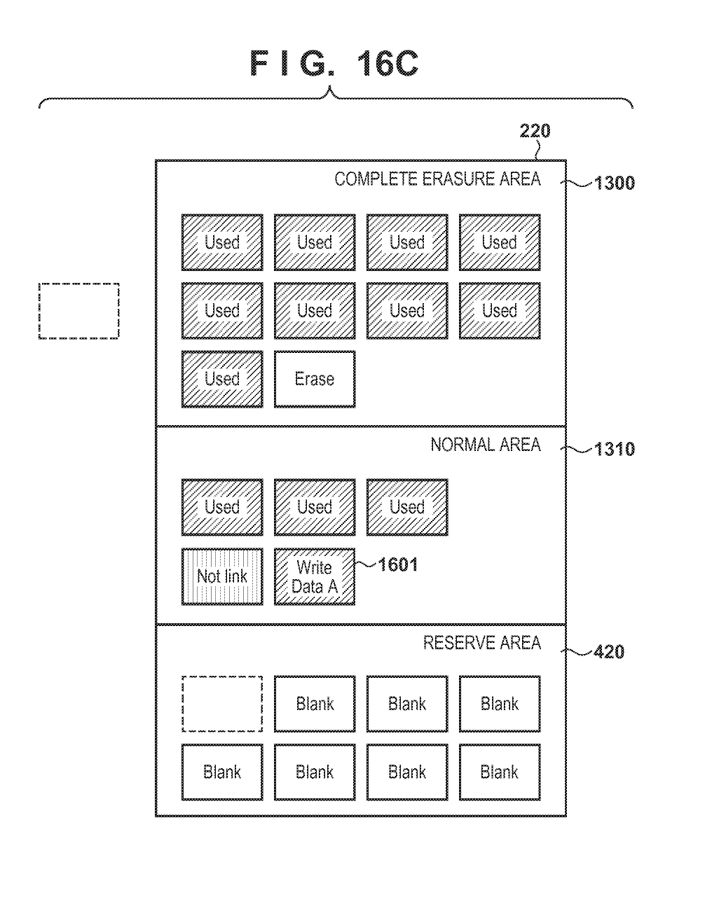

FIGS. 16A-16C are diagrams illustrating transitions in the link table 220 when the flash memory controller 20 writes data into the normal area 1310, according to this embodiment.

FIG. 16A illustrates a state in which the respective blocks are disposed in the complete erasure area 1300, the normal area 1310, and the reserve area 420. Here as well, the data to be written into the flash memory 30 by the flash memory controller 20 is the write data A (400). FIG. 16B illustrates a state in which an empty block 1601 in the reserve area 420 is moved to the normal area 1310 in step S1405 due to a data write command for the normal area 1310 being received.

The process then advances to step S1406, where the CPU 110 writes the data A (400) into a block of the flash memory 30 corresponding to the empty block 1601 moved to the normal area 1310, after which the process ends. FIG. 16C illustrates this state.

Meanwhile, in step S1407, the CPU 110 moves a block in the reserve area 420 to the main area 410 through a normal write process for the case where the main area is not divided into the complete erasure area 1300 and the normal area 1310, as illustrated in FIGS. 5 and 6A-6C. The process then advances to step S1408, where the CPU 110 writes the data A (400) into a block of the flash memory 30 corresponding to the block moved to the main area 410 in step S1407, after which the process ends.

In this manner, when the complete erasure function is enabled, upon a write command being received, whether or not to dispose, in the complete erasure area, the block into which that data is to be written is controlled using the link table 220 based on whether or not the block into which that data is to be written corresponds to the complete erasure area. As a result, the processing performed when an erase command for that data is received varies as described hereinafter.

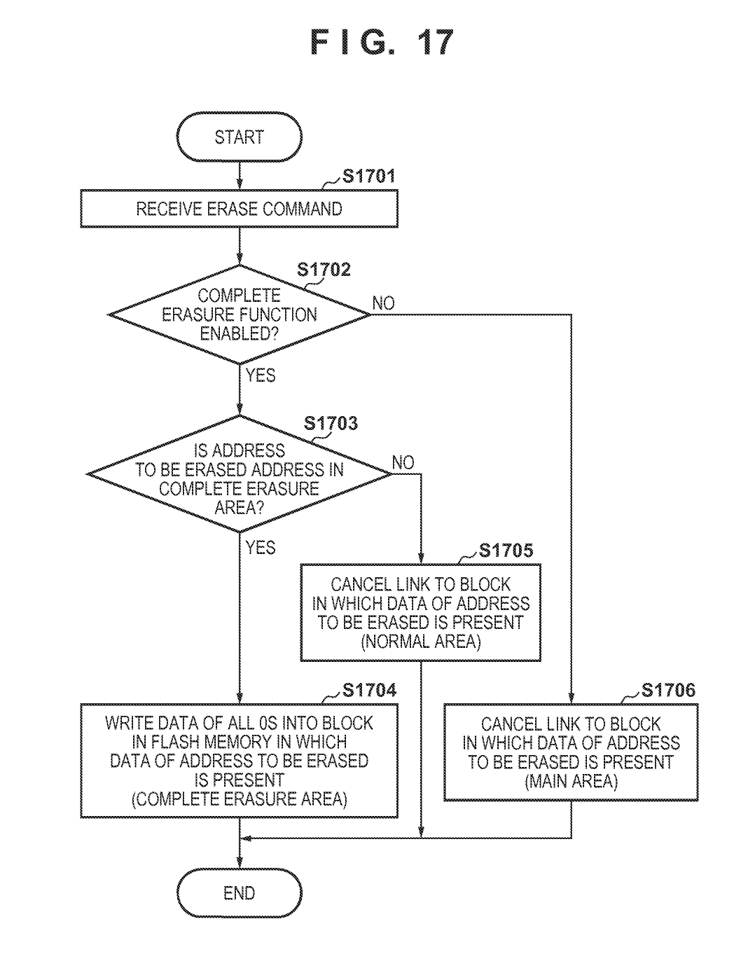

FIG. 17 is flowchart illustrating processing performed when an erase command is received in the case where the flash memory controller 20 divides the main area 410 of the link table 220 into the complete erasure area 1300 and the normal area 1310, according to the first embodiment. The programs for executing this process are stored in the ROM 111, and the process is realized by the CPU 110 executing those programs.

First, in step S1701, the CPU 110 receives an erase command from the system controller 10. The process then advances to step S1702, where the CPU 110 determines whether or not the complete erasure function is enabled, based on the complete erasure function settings stored in the flash memory 30. The process advances to step S1703 when it is determined that the complete erasure function is set to be enabled, whereas the process advances to step S1706 when it is determined that the function is set to be disabled. In step S1703, the CPU 110 determines whether or not the address instructed to be erased is an address belonging to blocks in the complete erasure area 1300. The process advances to step S1704 when it is determined that the address to be erased is an address belonging to blocks in the complete erasure area 1300, whereas the process advances to step S1705 when it is determined that the address to be erased is an address corresponding to a block in the normal area 1310.

In step S1704, the CPU 110 overwrites the blocks in the flash memory 30 having the address to be erased with data of all “0”s, after which the process ends. On the other hand, in step S1705, the address to be erased corresponds to a block in the normal area 1310, and thus the CPU 110 cancels the link of the block corresponding to the address to be erased, after which the process ends.

Meanwhile, when the complete erasure function is set to be disabled, the process advances to step S1706, where the CPU 110 executes the same processing as that for the normal operations illustrated in FIG. 7 due to the complete erasure function being disabled. In other words, the links to blocks in the flash memory 30 having the designated address, present in the main area 410, are canceled, and the process ends.

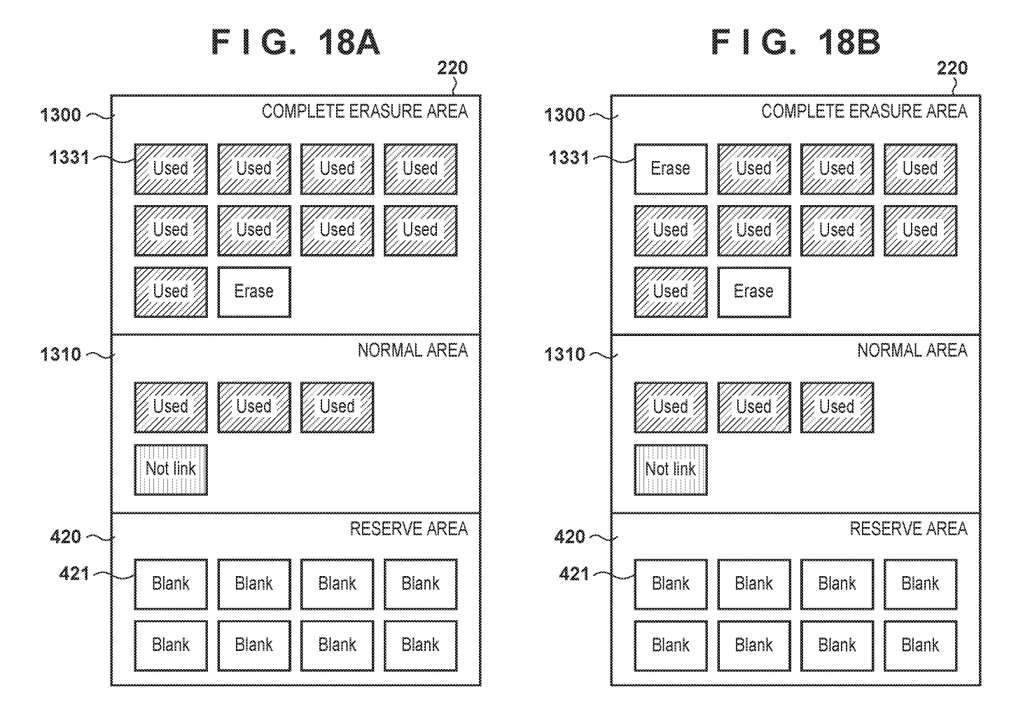

FIGS. 18A and 18B are diagrams illustrating transitions in the link table 220 when the flash memory controller 20 erases data in the complete erasure area 1300, according to the first embodiment.

FIG. 18A is a diagram illustrating the state of the link table 220 before the flash memory controller 20 receives a command to erase the data in a target address in the complete erasure area 1300.

The flash memory controller 20 executes complete erasure in the case where blocks in the flash memory 30 corresponding to the blocks 1331 in the complete erasure area 1300 are to be erased. At this time, the blocks in the flash memory 30 corresponding to the blocks 1331 are erased, and data of all “0”s is written into those blocks. FIG. 18B illustrates this state.

In this manner, according to the first embodiment, when erasing the data of the blocks in the flash memory 30 corresponding to the blocks 1331 in the complete erasure area 1300, data of all “0”s are written into those blocks.

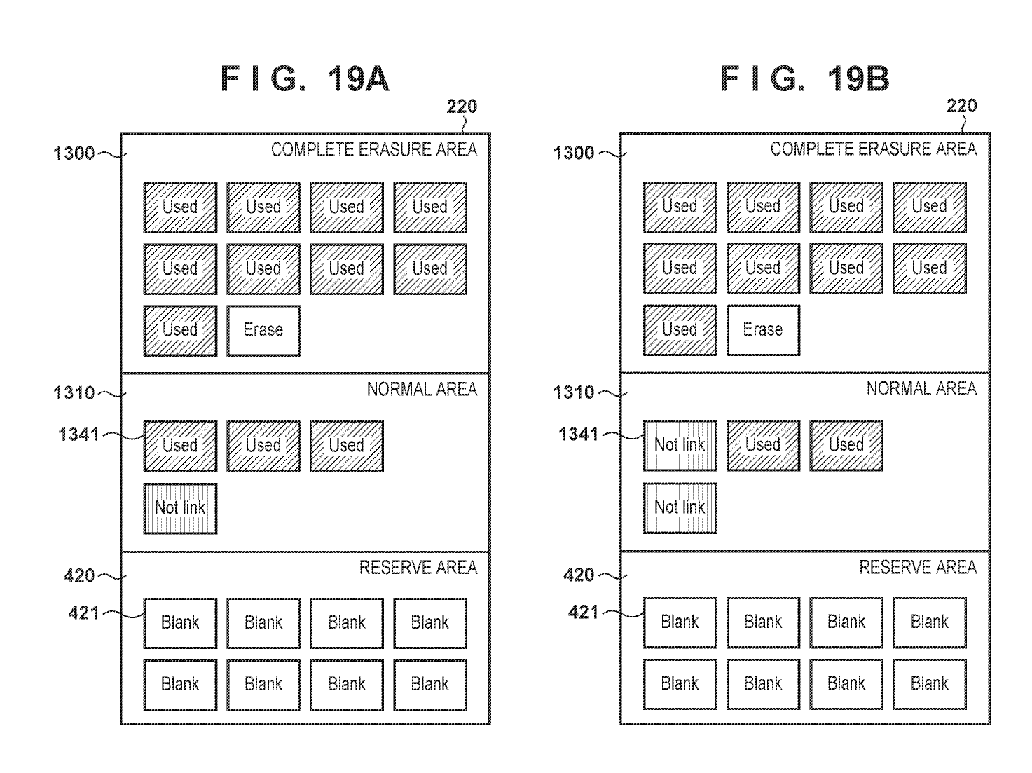

FIGS. 19A and 19B are diagrams illustrating changes in blocks in the case where the flash memory controller 20 has received a command to erase the data at an address in the normal area 1310, according to the first embodiment.

FIG. 19A illustrates the state of the link table 220 before a command to erase the data at the address in the normal area 1310 is received.

FIG. 19B illustrates a state in which a link of the blocks 1341 is canceled in the link table 220 upon the data in the flash memory 30 corresponding to the blocks 1341 in the normal area 1310 being erased. In this manner, according to the first embodiment, when erasing the data from a block in the flash memory 30 corresponding to a block that does not belong to the complete erasure area, the link to the data is canceled, but the data remains in that block.

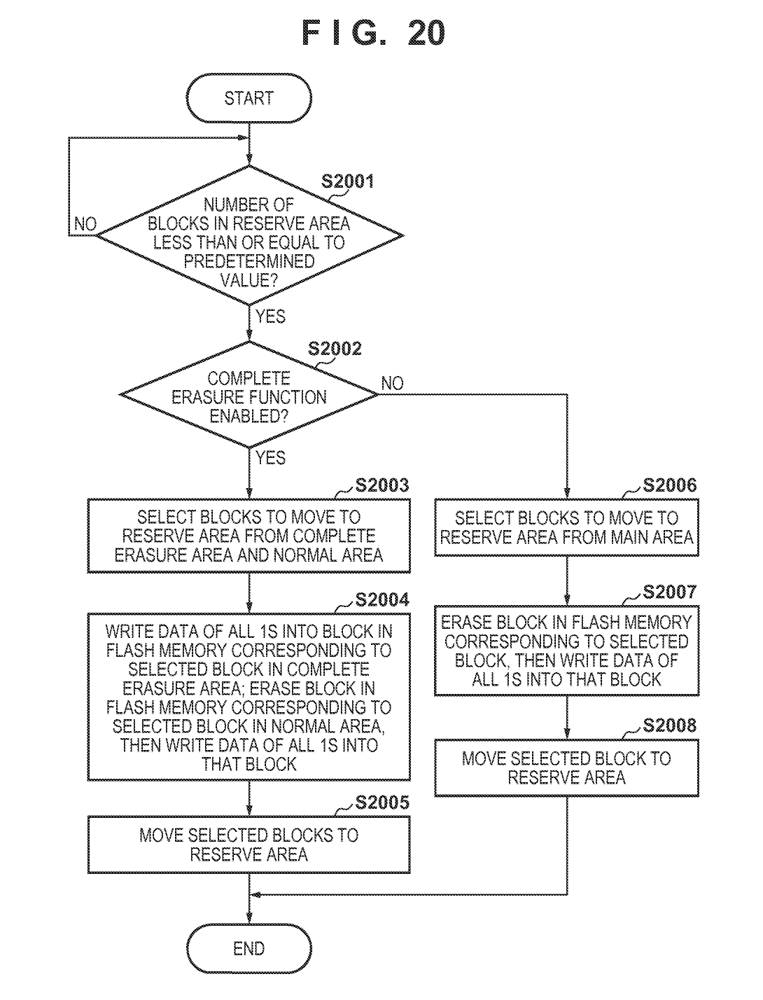

FIG. 20 is flowchart illustrating a block initialization process carried out in the case where the flash memory controller 20 divides the main area 410 of the link table 220 into the complete erasure area 1300 and the normal area 1310 and manages those areas separately, according to the first embodiment. The programs for executing this process are stored in the ROM 111, and the process is realized by the CPU 110 executing those programs.

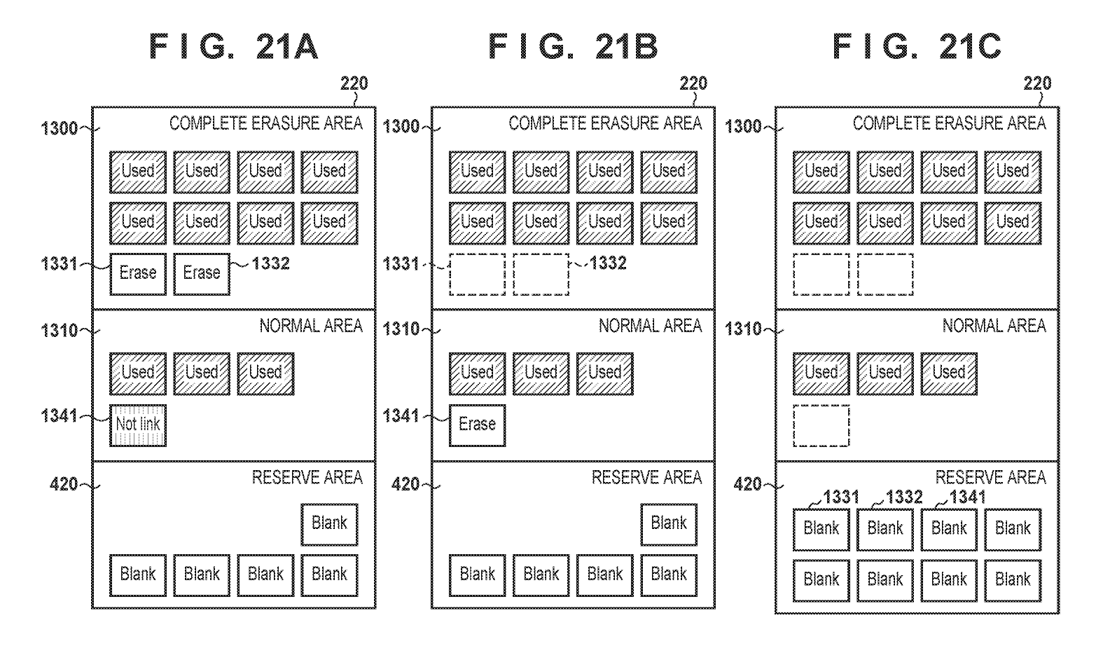

FIGS. 21A-21C are diagrams illustrating transitions in the link table during the block initialization process illustrated in FIG. 20. FIG. 21A illustrates a state occurring before the block initialization process is executed, FIG. 21B illustrates a state occurring while the block initialization process is being executed, and FIG. 21C illustrates a state occurring after the block initialization process is complete. Hereinafter, the flowchart in FIG. 20 will be described with reference to FIGS. 21A-21C.

First, in step S2001, the CPU 110 determines whether or not the number of empty blocks 421 in the reserve area 420 of the link table 220 is less than or equal to a predetermined value. In FIG. 21A, there are five empty blocks 421 in the reserve area 420, and here, the predetermined value is assumed to be eight. When it is determined in step S2001 that the number of empty blocks 421 is less than or equal to the predetermined value, the process advances to step S2002, where the CPU 110 reads out the setting information of the complete erasure area stored in the flash memory 30 and determines whether or not the complete erasure function is enabled. The process advances to step S2003 when the CPU 110 determines that the function is enabled, and advances to step S2006 when the CPU 110 determines that the function is disabled.

In step S2003, the CPU 110 selects blocks to be moved to the reserve area 420 from the complete erasure area 1300 and the normal area 1310. The conditions for the selection may be such that, for example, priority is given to moving blocks having the fewest number of erasures to the reserve area 420, but another method may be used instead. In FIG. 21A, the number of erased blocks 1331 and 1332 in the complete erasure area 1300 is two, and the number of blocks 1341 whose links have been canceled in the normal area 1310 is one, and thus these blocks are selected to be moved to the reserve area 420.

The process then advances to step S2004, where the CPU 110 writes data of all “1”s into the blocks in the flash memory 30 corresponding to the blocks 1331 and 1332 selected in the complete erasure area 1300. Meanwhile, the blocks in the flash memory 30 corresponding to the block 1341 selected in the normal area 1310 are erased by writing data of all “0”s thereto, and are then initialized by writing data of all “1”s thereto. The process then advances to step S2005, where the CPU 110 moves the blocks selected in step S2003 to the reserve area 420.

FIG. 21B illustrates a state where the processing of step S2004 is complete. Meanwhile, FIG. 21C illustrates a state in which the initialized blocks 1331, 1332, and 1341 have been moved to the reserve area 420.

The processing of steps S2006-S2008 is the same as that of steps S1002-S1005 in FIG. 10, and will thus be described only briefly.

In step S2006, the CPU 110 selects blocks to move to the reserve area 420 from the main area 410. The process then advances to step S2007, where the CPU 110 erases the blocks selected in step S2006 by writing data of all “0”s thereto, and then initializes those blocks by writing data of all “1”s thereto. The process then advances to step S2008, where the CPU 110 moves the blocks selected in step S2006 from the main area 410 to the reserve area 420, after which the process ends.

In this manner, when the number of empty blocks in the reserve area 420 is less than or equal to a predetermined value, those blocks can be replenished by blocks that have been erased or whose links have been canceled from the main area or, when the complete erasure function is enabled, the complete erasure area or the normal area.

In this manner, according to the present embodiment, the blocks in the main area are divided into a complete erasure area and a normal area, that is the same as the conventional main area, and the data is completely erased only from blocks corresponding to the complete erasure area, while only the links are canceled for the other blocks. Through this, the time required to erase the data can be reduced as compared to the case where the data in blocks corresponding to all of the blocks in the main area is completely erased.

### Other Embodiments

Embodiments of the present invention can also be realized by a computer of a system or apparatus that reads out and executes computer executable instructions (e. g., one or more programs) recorded on a storage medium (which may also be referred to more fully as a ‘non-transitory computer-readable storage medium’) to perform the functions of one or more of the above-described embodiments and/or that includes one or more circuits (e. g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e. g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™, a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-066810, filed Mar. 27, 2014, which is hereby incorporated by reference herein in its entirety.

What is claimed is:

1. A memory control apparatus that controls access to a non-volatile storage device, the apparatus comprising:
an addressing unit configured to associate logical addresses with physical addresses in the non-volatile storage device;
a setting unit configured to set a complete erasure mode for completely erasing data in the non-volatile storage device;
a management unit configured to divide the physical addresses in the non-volatile storage device into addresses for complete erasure and other addresses and manage those addresses in a divided manner in a case where the complete erasure mode is set by the setting unit;
a determination unit configured to, in a case where data stored in the non-volatile storage device has been instructed to be erased based on a logical address, determine whether or not a physical address associated with the logical address belongs to the addresses for complete erasure; and
a control unit configured to carry out control for completely erasing data at the physical address associated with the logical address in a case where it is determined by the determination unit that the physical address belongs to the addresses for complete erasure, and canceling a link to the data at the physical address associated with the logical address in a case where it is determined by the determination unit that the physical address does not belong to the addresses for complete erasure.

2. The memory control apparatus according to claim 1,
wherein the setting unit is configured to set the complete erasure mode in accordance with a command from an external apparatus.

3. The memory control apparatus according to claim 2,
wherein the command further includes an address in the non-volatile storage device that is subject to the complete erasure mode.

4. The memory control apparatus according to claim 1,
wherein the non-volatile storage device is a NAND flash memory.

5. An information processing apparatus that accesses a non-volatile storage device, the apparatus comprising:
an addressing unit configured to associate logical addresses with physical addresses in the non-volatile storage device;
a setting unit configured to set a complete erasure mode for completely erasing data in the non-volatile storage device;
a management unit configured to divide the physical addresses in the non-volatile storage device into addresses for complete erasure and other addresses and manage those addresses in a divided manner in a case where the complete erasure mode is set by the setting unit;
a determination unit configured to, in a case where data stored in the non-volatile storage device has been instructed to be erased, determine whether or not a physical address of the data belongs to the addresses for complete erasure; and
a control unit configured to carry out control for completely erasing the data in a case where it is determined by the determination unit that the physical address belongs to the addresses for complete erasure, and canceling a link between the data and a logical address in a case where it is determined by the determination unit that the physical address does not belong to the addresses for complete erasure.

6. The information processing apparatus according to claim 5,
wherein the control unit is configured to, in the case where the data stored in the non-volatile storage device is instructed to be completely erased in the complete erasure mode, overwrite the data with data of all “0”s.

7. The information processing apparatus according to claim 5,
wherein the addressing unit is configured to associate the logical addresses with the physical addresses in the non-volatile storage device at a block level.

8. The information processing apparatus according to claim 7, further comprising:
a writing unit configured to, when writing data into a block having a physical address that is to be completely erased, write the data after first writing data of all “1”s into the block, and when writing data into a block having a physical address that is not to be completely erased, write data of all “0”s into that block, write data of all “1”s into that block, and then write the data.

9. A control method for controlling a memory control apparatus that controls access to a non-volatile storage device, the method comprising:
associating logical addresses with physical addresses in the non-volatile storage device; setting a complete erasure mode for completely erasing data in the non-volatile storage device;
dividing the physical addresses in the non-volatile storage device into addresses for complete erasure and other addresses and managing those addresses in a divided manner in a case where the complete erasure mode is set in the setting step;
determining, in a case where data stored in the non-volatile storage device has been instructed to be erased based on a logical address, whether or not the physical address associated with the logical address belongs to the addresses for complete erasure; and
carrying out control for completely erasing data at the physical address associated with the logical address in a case where it is determined in the determining step that the physical address belongs to the addresses for complete erasure, and canceling a link to the data at the physical address associated with the logical address in a case where it is determined in the determining step that the physical address does not belong to the addresses for complete erasure.

10. A control method for controlling an information processing apparatus that accesses a non-volatile storage device, the method comprising:
associating logical addresses with physical addresses in the non-volatile storage device;
setting a complete erasure mode for completely erasing data in the non-volatile storage device;
dividing the physical addresses in the non-volatile storage device into addresses for complete erasure and other addresses and managing those addresses in a divided manner in a case where the complete erasure mode is set in the setting step;
determining, in a case where data stored in the non-volatile storage device has been instructed to be erased, whether or not a physical address of the data belongs to the addresses for complete erasure; and
carrying out control for completely erasing the data in a case where it is determined in the determining step that the physical address belongs to the addresses for complete erasure, and canceling a link between the data and the logical address in a case where it is determined in the determining step that the physical address does not belong to the addresses for complete erasure.

11. A non-transitory computer-readable storage medium storing a computer program for causing a computer to execute steps of a control method for controlling a memory control apparatus according to claim 9.

12. A non-transitory computer-readable storage medium storing a computer program for causing a computer to execute steps of a control method for controlling an information processing apparatus according to claim 10.
